(19) United States
(12) Patent Application Publication
(10) Pub. No.: US 2019/0125074 A1
(43) Pub. Date: May 2, 2019

(54) SMART DESK

(71) Applicant: Chung-Sheng CHENG, Taoyuan City (TW)

(72) Inventor: Chung-Sheng CHENG, Taoyuan City (TW)

(21) Appl. No.: 16/158,760

(22) Filed: Oct. 12, 2018

(30) Foreign Application Priority Data
Nov. 2, 2017 (TW) 106216282

(51) Int. Cl. A47B 21/02; A47B 21/06; H02M 3/137; H02J 50/12; H02J 7/04

(52) U.S. Cl. CPC A47B 21/02; A47B 21/06; H02M 3/137; H02J 50/12; A47B 2220/0075; A47B 2021/066; A47B 2200/0081; A47B 2200/0082; H02J 7/04

(57) ABSTRACT

A smart desk includes a desk body and at least one desk leg. The desk body includes a desktop and a DC power supply installed on the desk body. In addition, the DC power supply includes a voltage adjustment unit connected thereto in order to adjust an output DC voltage value depending upon the needs. The desk leg is attached onto the bottom surface of the desk body for supporting thereof. Accordingly, the smart desk is able to provide the functions of reading, office working, item storage, and providing a DC power source.

### BACKGROUND OF THE INVENTION

### Field of the Invention

The present invention is related to a smart desk, in particular, to a smart desk capable of providing a direct current (DC) power source.

### Description of Related Art

With the advancement of technologies, various types of electronic devices and products, including mobile phones, tablet computers, cameras, notebook computers, portable gaming devices, provide great convenience to the living standard of people. To satisfy the timely charging and continuous power demands of the aforementioned electronic devices, users often need to seek alternate current (AC) power sockets on interior walls, including constant removal of tables and desks to find such power sockets; likewise, in such situation, users also need to return tables and desks back to their original positions once the electronic device plugs are inserted into the wall power sockets, which can be extremely inconvenient to users during the use thereof, and the drawback of insufficient length of transmission cable is also troublesome to users. Accordingly, it is known that a table integrated with AC power socket is available in the market such that users are not required to move any table or desk to access the power socket for electronic devices or appliances. Nevertheless, such method still requires the use of an AC-to-DC adapter and transmission cables for 3C electronic device users in order to perform the charging of the electronic devices. As a result, the problems of inconvenience of use and cable management for users still exist in such known art.

### SUMMARY OF THE INVENTION

An objective of the present invention is to provide a smart desk capable of integrating the functions of reading, office work or item storage while providing a DC power source at the same time.

To achieve the aforementioned objective, the present invention provides a smart desk comprising a desk body and at least one desk leg. The desk body comprises a desktop and a DC power supply installed on the desk body; wherein the DC power supply includes a voltage adjustment unit connected thereto in order to adjust an output DC voltage value depending upon the needs, and the desk leg is attached to a bottom surface of the desk body for supporting thereof.

The present invention is able to achieve the following technical effects. Since the voltage adjustment unit inside the DC power supply of the present invention is equipped with the functions of voltage conversion for DC (or AC) power source, rectification, filtering and power adjustment in order to stably output a DC voltage (i.e. DC to DC/AC to DC), there is no need for an additional AC-to-DC adapter and transmission cables to achieve the power plug of existing 3C electronic devices for charging directly such that the use and charging thereof can be swift and convenient.

In an exemplary embodiment of the present invention, the smart desk comprises a transmission cable externally connected to the DC power supply and a plug connected to one end of the transmission cable. With the plug, such as USB, supplying DC power directly to a 3C electronic device or product equipped with a USB socket, the convenience of charging can be increased. Since the DC power supply at least includes a control unit and a load detector, it is able to achieve the function of voltage increase or decrease. The control unit is able to identify a load signal of the electronic device coupled thereto and to control the voltage adjust unit to output the DC voltage value corresponding to the needs thereof, such as the voltage value of 5V, 9V, 12V or 20V, for charging or use.

In another exemplary embodiment of the present invention, the smart desk further comprises the devices of a wireless charging module, a power storage unit, a DC power socket and an AC power socket connected to the DC power supply. The aforementioned various devices and DC power supply are embedded inside the desk body or the desktop at the same time in order to achieve greater concealing appearance of such devices on the desk body/desktop without occupying the original space of the desktop, as well as to achieve the advantage of maintaining the integrity of the desk body/desktop without destruction thereof. As a result, under the premises where the overall appearance of the desk body is maintained, the smart desk of the present invention is able to provide diverse, functional and convenient uses to users.

### BRIEF DESCRIPTION OF DRAWING

FIG. 1 is a perspective view of the smart desk of the present invention;

FIG. 2 is a front view of the smart desk of the present invention; and

FIG. 3 is a circuit diagram of the DC power supply of the smart desk of the present invention.

### DETAILED DESCRIPTION OF THE INVENTION

The following provides a detailed technical content of the present invention along with the accompanied drawings. However, the accompanied drawings are provided for reference and illustrative purpose only such that they shall not be used to limit the scope of the present invention.

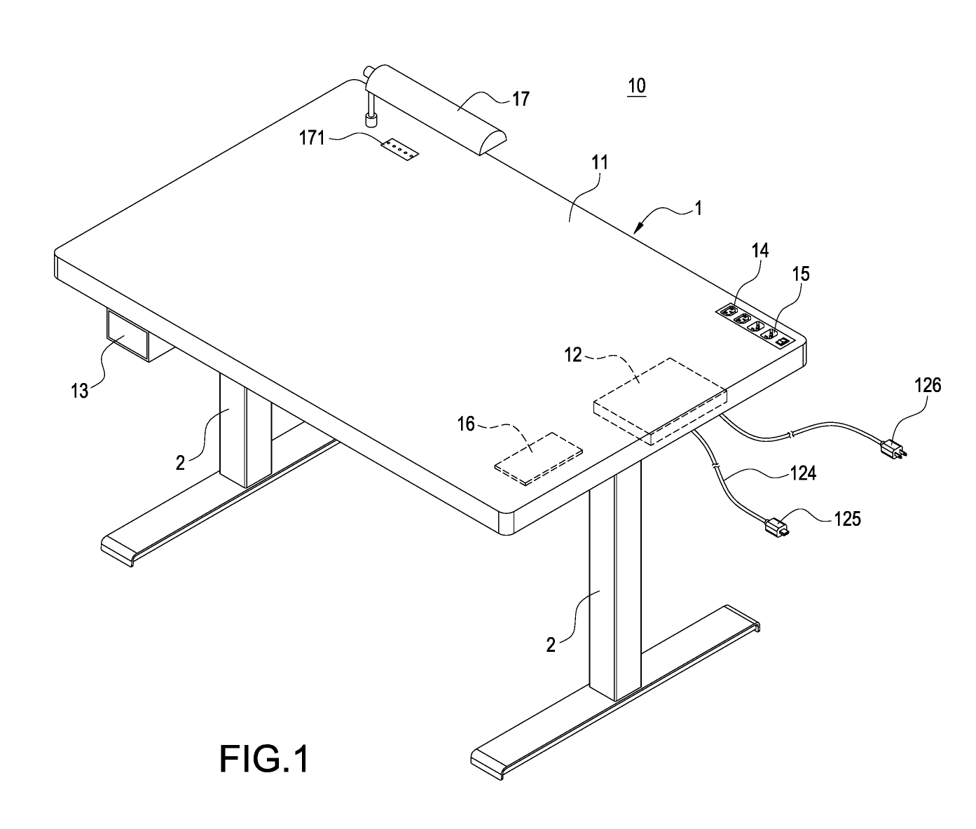

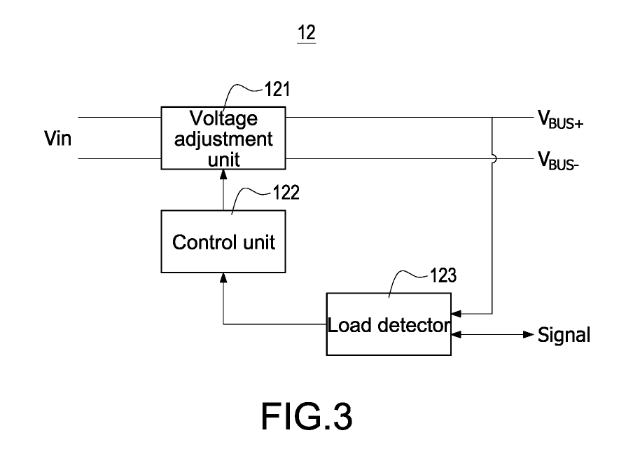

As shown in FIG. 1 to FIG. 3, the present invention provides a smart desk 10, comprising a desk body 1 and at least one desk leg 2. The smart desk 10 described hereinafter can be applied to a modern desk, office desk, storage desk or other suitable desks and tables, such that the present invention is not limited to any particular type of desk or table. In addition, the shape of the desk body 1 described in the exemplary embodiments of the present invention can be of a rectangular shape but the present invention is not limited to such shape only.

It shall be noted that the DC voltage provided by the smart desk 10 of the present invention is devoid of the impacts caused by the factors of the so-called peak values, power factor, frequency phase difference and harmonic interference; therefore, the DC voltage provided directly has the characteristics of relatively higher stability, facilitated storage, lower cost and wide applications in comparison to AC voltage. Furthermore, the DC power supply 12 of the present invention utilizes its voltage adjustment unit/circuit in order to perform voltage increase/decrease on the DC/AC voltage for outputting DC voltage again. The following provides a detailed description on the structure of exemplary embodiments of the smart desk of the present invention.

As sown in FIG. 1 to FIG. 3, the desk body 1 comprises a desktop 11 and a DC power supply 12 installed on the desk body 1; wherein the DC power supply 12 is electrically connected to a voltage adjustment unit 121 in order to adjust an output DC voltage value (not shown in the drawings) depending upon the needs. In an exemplary embodiment of the present invention, the voltage adjustment unit 121 is preferably built inside the DC power supply 12; however, in other different embodiments, the voltage adjustment unit 121 can also be separated from the DC power supply 12 by using a cable (not shown in the drawings) for connection thereto such that the configuration can be changed depending upon the needs. In an exemplary embodiment shown in FIG. 1, the DC power supply 12 is preferably embedded at the desk body 1 or inside the desktop 11. In addition, it can also include or not include a transmission cable 124 externally connected to the DC power supply and a plug 125 connected to one end of the transmission cable 124 in order to facilitate the DC voltage charging of various types of 3C electronic devices or products (not shown in the drawings) equipped with sockets (not shown in the drawings).

However, in other different embodiments, one end of the transmission cable 124 can also be connected to, such as, a DC plug or other suitable connectors such that the configuration can be changed depending upon the needs. Accordingly, the smart desk 10 of the present invention is able to provide the functions of reading, office works, item storages as well as the function of providing DC power for charging.

It shall be noted that the DC power supply 12 further comprises a control unit 122 and a load detector 123; wherein the control unit 122 is able to identify a load signal of the aforementioned electronic device or product and to control the voltage adjustment unit 121 in order to output the DC voltage value required. In other words, the load detector 123 is able to detect changes of the resistance or current (signal) change of the electronic device or product connected, and the control unit 122 controls the voltage adjustment unit 121 such that it is not affected by the fluctuation of the input voltage or the change of the load voltage in order to maintain a corresponding and stable output voltage. The DC voltage value can be 5V, 9V, 12V, 20 V or any other suitable voltage value, and the present invention is not limited to any particular value.

In addition, the DC power supply 12 is able to supply power through an external power cord 126 connected to the grid electricity. Alternatively, the power of the DC power supply 12 can be supplied by a power storage unit 13. The power storage unit 13 described herein refers to a one-time use of lithium battery or a storage battery or a lithium-ion battery rechargeable for repetitive uses, and the present invention is not limited to any particular type of battery. Regardless the battery type of the power storage unit 13, the DC power supply 12 is able to convert the power supplied into a DC power source in order to facilitate the use thereof. In an exemplary embodiment of the present invention, the battery storage unit 13 can be installed on a bottom surface of the desk body 1/desktop 11 or can be selectively installed on one side of the desk leg 2 such that the configuration can be changed depending upon the needs.

Furthermore, in an exemplary embodiment of the present invention, the smart desk further comprises at least one DC power socket 14 and at least one AC power socket 15 electrically connected to the DC power supply 12 in order to respectively provide DC power to electronic devices or products requiring DC power or provide AC power to home appliances requiring AC power. As shown in FIG. 1, the AC power socket 15 can also be connected to the grid electricity via a power cord 126 in order to provide AC power such that it can be designed according to the needs. When home appliance equipment is plugged into the AC power socket 15, power can be supplied directly from the power storage unit 13 or can be coupled to the DC power supply 12 in order to utilize the control unit 122 therein to stabilize the voltage, followed by supplying power to the AC power socket 15; therefore, the configuration can be changed depending upon the needs. The DC power socket 14 and the AC power socket 15 can be arranged in parallel or can be arranged separately for embedded at the surface of the desk body 1/desktop 11 in order to allow electronic device or appliance equipment for plugging onto the sockets for use.

To facilitate the charging of 3C electronic devices and products, in an exemplary embodiment of the present invention, it further comprises a wireless charging module 16 electrically connected to the DC power supply 12 in order to prevent problems associated with the sorting and storage of cables due to excessive charging cables (not shown in the drawings). As shown in FIG. 1, the wireless charging module 16 is also embedded inside the desk body 1/desktop 11 and receives the power supplied from the DC power supply 12 in order to form a charging zone (not labeled in the drawings) on top of the desktop 11 adjacent to the wireless charging module. Consequently, it is able to generate electricity wirelessly through the electromagnetic resonance principle in order to perform wireless charging of the 3C electronic device or product placed adjacent to the charging zone.

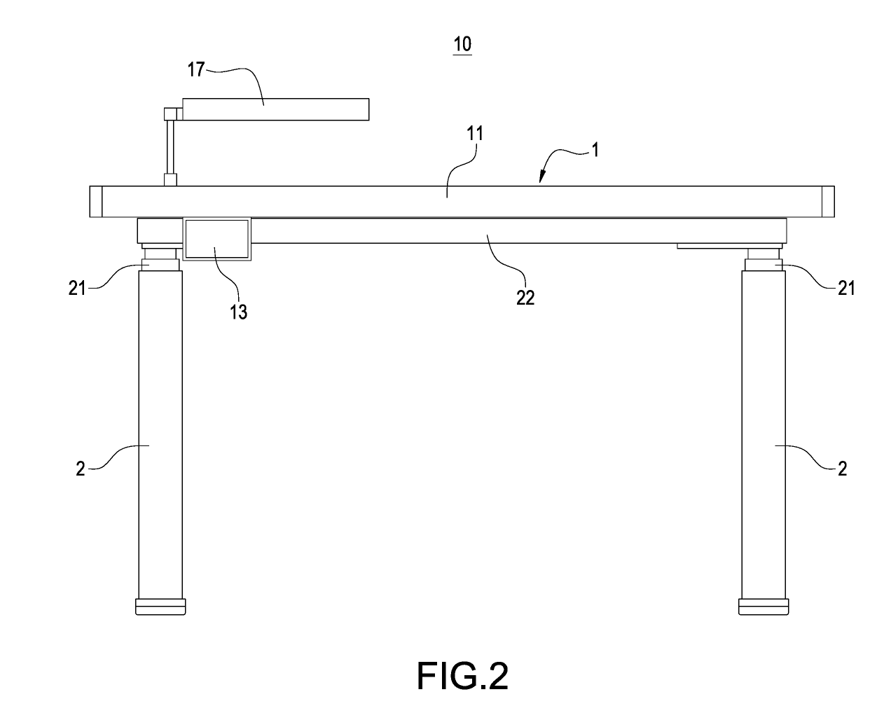

The desk leg 2 is attached onto the bottom surface of the desk body 1 for supporting thereof. As shown in the exemplary embodiment of FIG. 2, the quantity of the desk leg 2 is preferably 2 or more than 2, and each desk leg 2 includes an extendable shaft 21 and a supporting horizontal shaft 22 connected to the top end of the extendable shaft 21 in order to adjust the height of the desktop 11 synchronously. In an exemplary embodiment of the present invention, the extendable shaft 21 can be, such as, a pneumatic shaft or an electric shaft utilizing the power supplied from the DC power supply; therefore, it can be installed depending upon the needs. Furthermore, in an exemplary embodiment of the present invention, the smart desk 10 further comprises a LED lighting fixture 17 electrically connected to the DC power supply 12. The LED lighting fixture 17, for example, can be equipped with a control module 171 for adjusting the intensity of the light and is installed on the desktop 11 vertically.

Regarding various smart functions of the smart desk 10, such as the DC power socket 14, AC power socket, wireless charging module 16 and the LED lighting fixture 17, such devices and functions can be installed at appropriate locations of the desk body 1 depending upon the needs, and the present invention is not limited to the configuration of the exemplary embodiments described.

In view of the above, the exemplary embodiments described in this specification are provided to illustrate the present invention only such that the present invention shall not be limited to such embodiments only. The scope of the present invention shall be defined by the claims described hereinafter and the scope shall cover all equivalent modifications such that it is not limited to the aforementioned description only.

What is claimed is:

1. A smart desk, comprising:
a desk body comprising a desktop and an DC power supply installed on the desk body;
wherein the DC power supply includes a voltage adjustment unit connected thereto in order to adjust an output DC voltage value depending upon the needs; and
at least one desk leg attached to the desk body and used for supporting a bottom surface thereof.

2. The smart desk according to claim 1, further comprising a transmission cable externally connected to the DC power supply and a plug connected to one end of the transmission cable.

3. The smart desk according to claim 1, wherein the DC voltage value is any one of the values of 5V, 9V, 12V or 20V.

4. The smart desk according to claim 1, wherein the DC power supply further comprises a control unit and a load detector; the control unit is configured to identify a load signal connected thereto and to control the voltage adjustment unit to output the DC voltage value required.

5. The smart desk according to claim 1, further comprising a power storage unit configured to store a power of the DC power supply.

6. The smart desk according to claim 5, wherein the power storage unit is any one of a lithium battery, a storage battery or a lithium-ion battery.

7. The smart desk according to claim 6, wherein the power storage unit is selectively arranged at one side of a bottom surface of the desktop or the desk leg.

8. The smart desk according to claim 1, further comprising at least one DC power socket and at least one AC power socket electrically connected to the DC power supply; the DC power socket and the AC power socket are arranged parallel to each other or separately embedded on a surface of the desktop.

9. The smart desk according to claim 1, further comprising a wireless charging module electrically connected to the DC power supply; wherein the wireless charging module is embedded on the desktop.

10. The smart desk according to claim 9, wherein the wireless charging module is installed inside the desktop, and the wireless charging module receives a power of the DC power supply in order to form a charging area on top of the desktop adjacent to the wireless charging module for wireless charging.

11. The smart desk according to claim 1, further comprising an LED lighting fixture electrically connected to the DC power supply; the LED lighting fixture is vertically installed on the desktop and is equipped with a light intensity adjustable function.

12. The smart desk according to claim 1, wherein a quantity of the desk leg is 1 or more than 1; each desk leg comprises an extendable shaft and a supporting horizontal shaft connected to the extendable shaft in order to adjust a height of the desktop.
